(19) United States
(12) Patent Application Publication
(10) Pub. No.: US 2024/0370103 A1
(43) Pub. Date: Nov. 7, 2024

(54) METHOD FOR OPERATING AN INPUT DEVICE AND INPUT DEVICE

(71) Applicant: INVENTUS Engineering GmbH, St. Anton i.M. (AT)

(72) Inventors: Stefan Battlogg, St. Anton i.M. (AT); Bernhard Raab, Vöcklabruck (AT); Martin Eberl, Gampern (AT); Mathias Brandl, Schruns (AT)

(21) Appl. No.: 18/688,640

(22) PCT Filed: Sep. 2, 2022
(86) PCT No.: PCT/EP2022/074422

§ 371 Date: Mar. 1, 2024

(30) Foreign Application Priority Data
Sep. 4, 2021 (DE) 10 2021 122 925.1
Sep. 6, 2021 (DE) 10 2021 123 033.0

(51) Int. Cl. G06F 3/0362; A63F 13/24; A63F 13/285; G06F 3/01; G06F 3/0338; G06F 3/0354; G06F 3/038

(52) U.S. Cl. CPC G06F 3/0362; A63F 13/24; A63F 13/285; G06F 3/016; G06F 3/0338; G06F 3/0383; G06F 3/03543

(57) ABSTRACT

A method for operating an input device and an input device. An input element of the input device is manually operated and pivoted to perform an input into the with the input device. A change in the angular position of the input element is detected by means of a sensor device. A signal is output, which is influenced by the change in the angular position of the input element. A freewheeling state of the pivotable input element is simulated from a starting time, from which the signal is output in the freewheeling state independent of the angular position of the input element.

The present invention relates to a method for operating an input device and to such an input device. At least one input element of the input device is actuated at least partially manually in order to carry out an input.

Such input devices are used, for example, as mouse wheels in computer mice or as control buttons on car steering wheels. Input devices known in the prior art have the disadvantage that the methods known for control only provide insufficient feedback for a user.

Mouse wheels and control rollers on motor vehicle steering wheels usually have a tactile grid in order to give the user haptic feedback when turning. This allows the user to control the input device in a more targeted manner.

But if the user, for example, wants to scroll through a long document on the computer with a computer mouse, you often have to turn the mouse wheel many times to get further. This can take a relatively long time and the user has to constantly turn the mouse wheel. Alternatively, the user can hold the scroll bar with the mouse button and pull it up or down on the screen to move forward or back more quickly. To do this, the user must realign the computer mouse on the screen and fix the scroll bar. It would be easier if the user could move through the document more quickly by turning the mouse wheel faster. One disadvantage, however, is the rasterization of the mouse wheel, which provides periodic resistance to the rotational movement. However, the grid is advantageous for the operating experience.

In contrast, the object of the present invention is to improve the usability of the input device. For example, the user, e.g., can navigate through longer lists more easily with a computer mouse or a control wheel on a motor vehicle. In particular, the ease of use and/or ergonomics should be improved and the user should be better supported when working with the input device. Preferably, the use of the input device and the execution of entries should be made more intuitive.

This object is achieved by methods having the features of claim 1 and by an input device having the features of claim 31. Preferred developments of the invention are the subject matter of the dependent claims. Further advantages and features of the present invention result from the general description and the description of the exemplary embodiments.

The method according to the invention serves to operate an input device, in particular for a computer device. At least one input element of the input device is actuated, at least partially, manually in order to carry out an input, in particular into the computer device which is operatively connected to the input device. The input element of the input device is an (at least) movable and in particular pivotable input element. The input element of the input device is actuated at least partially manually and in particular pivoted in order to carry out an input. At least one change in an angular position of the input element is detected by means of at least one sensor device. A signal is output which is influenced at least by the change in the angular position of the input element. A freewheeling state of the pivotable input element is simulated from a starting time. From the start time (after) is in the freewheeling state outputs a signal which is independent of the angular position of the input element.

The invention has many advantages. A significant advantage is that the input element does not have to offer any actual freewheeling. Freewheeling is simulated. For this purpose, a freewheeling state is started.

The start time is preferably set when the user issues a start command, it being possible in particular for the start command to be triggered by pressing a button or a switch, or acoustically or optically. This can be done by pressing a button or a button or a special switch. Speech recognition or gesture recognition is also possible.

The start command is particularly preferably triggered (automatically) when a characteristic value for a change in the angular position of the input element over time exceeds a predetermined level. For this purpose, the angular positions of the input element over time are compared and movements and/or accelerations of the input element are determined therefrom. At least one characteristic value is derived from the determined movement data.

The characteristic value is preferably derived (continuously or periodically) and compared with the predetermined measure. If the characteristic value reaches or exceeds the predetermined level, the start command is triggered and the start time (simulation start time) for a freewheeling state is specified. In particular, the start time (immediately following) is set. From the start time, a freewheel or freewheeling state is simulated and practically pretended that the input element has a freewheeling function. It is irrelevant whether the input element actually continues to rotate and how long it rotates. It is pretended to keep spinning.

With the start command or from the start time, a freewheeling state of the rotatable input element is simulated. In the freewheeling state, a signal is output which is independent of the angular position of the input element. In the context of the present invention, pivoting is also understood to mean turning. It does not matter whether continuous rotation is possible or occurs.

When determining the characteristic value, it is possible to draw conclusions about speeds and accelerations from changes in the angular position over time due to rotary and/or pivoting movements.

In a simulated freewheeling state or during the simulation of a freewheeling state, the signal that is output does not usually depend on the position or angular position of the input element.

The invention makes it possible to equip conventional input devices with a “freewheel function”. A single “nudge” is sufficient to e.g., achieve continuous scrolling in text on the screen with a computer mouse. The input element can continue to rotate but does not have to. This can also be done with input devices that are not particularly smooth-running or that have a fixed grid.

However, the invention can of course also be implemented with smooth-running input elements, in which the freewheeling state can be extended virtually at will. The simulation of the freewheeling state can also be referred to as a virtual freewheeling function.

Preferably, the simulation of the freewheeling state is terminated (an end time is determined) when the user provides another input. This function can be adjustable and also configurable. Thus, the simulation of the freewheeling state can only be ended with certain inputs and/or when certain keys or certain gestures or acoustic commands are actuated.

For example, the freewheeling state can be terminated selectively when a specific control button, a mouse button, a switch is pressed or when the scroll wheel or a control roller is pressed.

The simulation of the freewheeling state is preferably ended (automatically) when the input element no longer rotates (and e.g., stands) and when the user then begins to rotate the input element, so that the sensor device detects a change in the angular position. This enables an advantageous mode of operation. The user can start the simulation of the freewheel state with certain movements (or other actions) and stop it again with a (slight) movement.

In advantageous refinements, the simulation of the freewheeling state is ended when the speed of the input element is actively changed (by the user) and the input element is braked or accelerated.

In particular, the simulation of the freewheeling state is ended when the input element is (still) rotating and the user actively changes the speed of the input element and brakes or accelerates the input element. A comparison with empirical values preferably takes place here. If a movement speed of the input element reduces over time (due to friction) to the expected extent, there is no reaction. If, on the other hand, acceleration or deceleration occurs beyond the expected extent, the end time is determined and the simulation is terminated.

Preferably, in the freewheeling state or during the simulation of the freewheeling state, a signal is output which is independent of the temporal change in the angular position of the input element during the freewheeling state. It is preferable to act as if it were continuing to rotate.

In preferred developments, the signal includes at least one parameter. At least one parameter can be taken from a group of parameters, which group (or the group) has a current angular position, a current rotational speed and a current angular acceleration and a current point in time and other directly recorded or derived values and the like. The consideration and transfer of several parameters or values allows a particularly delicate and precise control. The signal can be digital and/or analog. A current change in acceleration (jerk) can also be recorded here as an additional value, for example.

The signal preferably depends on the speed of the input element when the predetermined level is exceeded and/or on the acceleration of the input element when the predetermined level is exceeded.

In preferred developments, the characteristic value is derived from a speed and/or an acceleration of the input element. In addition, the characteristic value can also be derived from an angular position and/or from a change in acceleration and/or other (movement) parameters.

The behavior of the user is preferably evaluated by artificial intelligence. In particular, the signal is set in the freewheeling state as a function of the evaluation by the artificial intelligence. In this way, the input device can practically learn itself (or via the computer connected to it): The software then remembers the movement patterns of the input element in particular and uses these for the advantageous internal derivation of control structures and commands in particular (artificial intelligence).

It is preferred that the signal after the start time is greater than the signal at the time at which the characteristic value (for a change in the angular position of the input element over time) exceeds a predetermined level. This also means that the signal can be larger than at the maximum rotational speed of the input element. It is also possible that the signal is greater than at the maximum physically or ergonomically possible rotational speed. This is particularly useful when scrolling through (very) long lists or documents.

A level of the signal that is set immediately after the start time or with the start command can depend on the length of a document and/or the number of list entries in a list and/or the number of Mentie entries of a Mentis and/or a (still remaining) Travel distance depends. In particular, the signal becomes larger (and the scrolling speed increases) when the length of the document, list, etc. is larger.

The signal can also become smaller as the remaining length decreases or as the number of further list entries decreases. The scrolling speed can be reduced to the last 5%, 10% or 20%.

In all of the configurations and developments, the input element can be pivoted at least over a (small) angular range. In particular, the input element can be pivoted at least half a revolution or almost a full revolution. It is also possible and preferred that the input element can be rotated more than one revolution or even several revolutions. The input element can particularly preferably be rotated continuously.

In all embodiments, the signal can depend on the length of time from the start time. In particular, a temporal decrease in the speed of the input element can be simulated during the freewheeling state. Such a decrease can occur linearly or in stages. The associated values can be reduced linearly or exponentially or in another suitable manner. In particular, it is also possible to simulate a course that would occur with an actual freewheel, in which in reality the rotation speed decreases over time due to friction and the input element stops after a certain time. In addition, a signal can also be dependent on a direction of movement (e.g. forward/backward tick) and/or an (initial) speed and/or an (initial) acceleration. In addition, during the freewheeling state, an increase or another dependency, such a, for example, a periodic fluctuation in the speed of the input element can be simulated. Preferably, a (temporal) length of the freewheeling state is limited.

Preferably, at least one mobility of the input element can be deliberately delayed (i.e., preferably braked, and, in particular, damped) and/or held and in particular blocked and/or released by means of at least one controllable magnetorheological braking device. The mobility of the input element is specifically adapted in particular by means of at least one control device and/or in particular by the computer device at least as a function of at least one input condition stored in the computer device and/or in the input device. In particular, the mobility of the input element is adapted by means of an activation of the braking device. The input condition includes in particular a movement parameter of the input element.

Holding in the sense of this application includes, in particular, a very large delay in the mobility of the input element, which can only be overcome with great effort on the part of the operator. In contrast, a blocked input element can (practically) no longer be moved by the user.

The mobility of the input element can be adapted in a targeted manner at least as a function of at least one input condition, the input condition comprising at least one movement parameter.

In particular, the movement parameter includes at least one direction and/or one speed and/or the input condition an acceleration and/or a change in the acceleration of the movement of the input element. In addition, an angular position can preferably also be encompassed by the movement parameter.

The movement can be a linear movement, a pivoting movement and/or a rotary movement. It is also possible for a movement position, such as a rotation and/or swivel angle, to be used specifically as an input condition.

The adaptation of the mobility of the input element depending on the input condition is particularly advantageous. This allows the user to be specifically supported when working with the input device. In addition, the use of the input device is considerably more convenient and the implementation of inputs is made more intuitive. For example, an improvement in productivity and a reduction in the frequency of user errors can be achieved in this way. In particular, the use of the movement parameter advantageously allows haptic feedback to the user. The user receives the feedback directly based on their input and/or movement. A visual check of the input on the operator panel is not necessary. The user can advantageously feel directly how the input is processed, in particular by a connected computer device. People with diabetes can experience greatly reduced sensitivity to touch in the skin, e.g., in your fingers, which makes it difficult or even impossible to control a touch surface (touch-sensitive surface, such as the volume slider). A haptic feedback is very well perceived. In addition, the input conditions can also be stored and/or filed directly on the input device in a memory unit or by a computer device arranged in the input device. In this way, the input conditions can be stored directly in the user's device.

A particular advantage of such developments is that s an additional dimension is offered in which the mobility of the input element can be adjusted. One The first fundamental dimension in which the mobility of the input element can be adjusted is known, for example, from WO 2018/215350 A1. The adaptation of the mobility of the input element as a function of the angle of rotation is described there, so that grid points occur at certain intervals and can be felt (haptic feedback). The invention now makes it possible to superimpose this dimension with a further dimension of haptic feedback. For example, the mobility of the input element can be slowed down or even blocked (second dimension) if the user turns the control element between two grid points (first dimension) too quickly or accelerates too much or suddenly changes direction.

In particular, the method is used to operate a computer mouse. The method can also be used to operate a rotary knob and/or a scroll wheel and/or a thumb roller and/or a joystick and/or a haptic phone case and/or a smart device and/or another input device The operation of technical equipment in vehicles, (as rotary control; rotary/push control; for infotainment, air conditioning, as a gear selector switch, for navigation, for seat adjustment, in the steering or in the steering wheel, for operating the chassis adjustment, driving mode adjustment, distance setting, adaptive cruise control, trailer control . . . ), motor vehicles, aircraft and airplanes, ships, boats, in agricultural engineering (tractors, combine harvesters, harvesters, other field machines for agriculture, snow groomers . . . ), construction machines and machines for material handling (forklifts . . . ), processing machines and systems used in industry or in medical or industrial systems.

The invention can also be used in the operation or as an input device of/for washing machines, kitchen/household appliances and equipment, radios, cameras and film cameras, VR (virtual reality) and AI (artificial intelligence) devices, hi-fi and television systems, smart devices, smart home devices, laptops, PCs, smartwatches, in a crown wheel of wristwatches, or as an input device for computers, or as a computer mouse, or as a wheel in a computer mouse or controller, game consoles, gaming equipment, rotary knob in a keyboard, or other devices.

A computer or a mobile terminal to which the input device is connected can serve as the computing device. The computing device can also be part of another device or a machine or a vehicle. For example, the input device is then a thumb roller in the steering wheel of a vehicle. In particular, the computer device comprises at least one display device. In particular, the input device provides a human-machine interface (HID) or is part of one. In particular, the computer device includes at least one graphical user interface (GUI) and, for example, a monitor or a display or the like. In particular, information and, for example, an input made or the effects of an input made are displayed graphically on the graphical user interface.

The input condition stored in the computer device can be permanently stored. The input condition stored in the computer device can also be determined dynamically, for example as a function of a program or menu. The input condition can also be adjusted dynamically depending on the input, so that there is mutual feedback or dependency.

Bidirectional communication preferably takes place between the computer device and the input device. In particular, the input device can be controlled by the computer device and preferably vice versa. In particular, the computer device can control the braking device and preferably set the braking effect. For this purpose, at least one algorithm and, for example, software or a driver or the like is stored in the computer device. A manual actuation of the input device is understood to mean, in particular, any at least partially muscle-powered actuation. It can also be operated with the foot or with the head.

In the context of the present invention, deceleration is understood to mean, in particular, braking and particularly preferably also damping. A release is understood to mean, in particular, an at least partial reduction in the delay and in particular a cancellation of the delay. When the mobility of the input element is completely released, the braking device is in particular inactive. When released, a magnetorheological medium is preferably not influenced by a magnetic field actively generated by the braking device. When fully released, the input element is in particular freely movable and, for example, freely rotatable. In addition to a rotary movement, a pressure actuation and/or pull actuation can also be provided for the input element.

The method can also be carried out with input devices in which the input element has at least two degrees of freedom. The movability of the input element along a first degree of freedom is specifically blocked and/or in particular fixed by means of a magnetorheological braking device while the input element is actuated for input along the second degree of freedom and/or after the input element has been actuated for input along the second degree of freedom.

In particular, rotation of the input element is blocked by the braking device while the input element is pushed and/or pulled along the second degree of freedom. This offers, e.g., the particular advantage that no accidental input is made by turning while pressing or pulling (so-called push function or pull function). For example, pressing or pulling confirms an entry that was previously selected from a menu by turning. If the input element were accidentally turned while pressing or pulling, an incorrect menu item could be confirmed. Additionally, or alternatively, the rotatability of the input element can be blocked by means of the braking device if the input element has previously been pressed and/or if the input element has previously been pulled. Then no unwanted entries can be made afterwards. In particular, the blocking is canceled again by moving the input element again along the second degree of freedom. The blocking can also be automatically removed after a defined time.

In particular, a pivotal movement along the first degree of freedom is blocked by a linear movement along the second degree of freedom. For this purpose, the input element is preferably pressed and/or pulled in a targeted manner and/or pivoted about a pivot point which lies outside of the input device itself. In particular, the linear movement takes place transversely to the axis of rotation.

In this context, pressing and/or pulling is understood to mean in particular the actuation of at least one button and/or switch and/or a switching mechanism, which can be actuated by pressing, pulling, pivoting and/or turning. The actuation can be detected in particular by additional sensors.

In this way, a second and/or other parallel user input is advantageously suppressed in a targeted manner. This is particularly advantageous if an input is to be isolated from other inputs, such as rotary and/or pivoting movements.

In further developments, the method can also be carried out with input devices in which the mobility of the input element is deliberately delayed, held and in particular locked in particular by means of a magnetorheological braking device is blocked and released and in which the mobility of the input element is predetermined and/or influenced at least as a function of a profile. The profile includes, for example, at least two, three, four, five, ten, twenty, fifty, one hundred or more input conditions that are at least partially dependent or independent of one another. In particular, the profile is specified at least in part by a user.

Movability of the input element is advantageously controlled at the same time as a function of at least two input conditions. Advantageously, the profile can have a plurality or also a large number of input conditions. In particular, a profile contains all the necessary input conditions for controlling a connected computer device. Advantageously, the profiles can be easily exchanged. In addition, it is also possible for the input conditions of the profile to be adjustable and adaptable together and depending on one another. The profile enables transmission of input conditions for controlling the magnetorheological braking device. For example, game profiles for connected computer devices can be adapted and transferred between different computer devices. A profile can, for example, specifically influence the strength and/or the intensity of the deceleration of the movement of the input device to change the braking effect of the magnetorheological braking device.

Particularly advantageously, the input conditions of the profile can be individually adapted by at least one user interface using a computer device. For example, it is possible to select from a large number of predefined profiles and to further adapt them to individual needs. Here the adaptation takes place in particular as a function of the movement parameters of the input element.

In at least one advantageous embodiment, within a range of movement of the input element generates a grid with stop points by the braking device, which influences the movability and a movement of the input element. The grid with the stop points advantageously allows feedback for the user about the movement that has been carried out.

In at least one advantageous development, a distance between at least two stop points lying next to one another within the grid is changed at least partially as a function of the movement parameter of the movement of the input element. This advantageously enables improved feedback for a user of the input element of the input device. It is also possible that the grid itself changes depending on the motion parameter of a motion.

At least one stop point is preferably skipped over and/or left out depending on the movement parameter of the movement of the input element. In addition, it is possible for individual stop points to be left out and/or skipped depending on a position of the input element. In this way, quick movements can advantageously be carried out without disturbing attachment points for the user. Advantageous operation is made possible. It is also possible for the user to feel the attachment points in one direction of movement. As a result, the user advantageously receives feedback, for example if an input is to be variable depending on the direction. In addition, it is possible that a grid is only noticeable to the user at low accelerations.

In at least one advantageous embodiment, the grid has between 3 and 200 stop points. The grid advantageously has in particular between 5 and 100 stop points.

Preferably, when program elements are wiped over (so-called mouseover) the mobility of the input element is set depending on a type of the program element being monitored and/or depending on an input condition for the program element being monitored.

In an advantageous embodiment, the input element is used for scrolling and is preferably used. The mobility of the input element is preferably set and changed depending on the scrolling and in particular set depending on the currently displayed page information and/or other displayed information. The scrolling takes place in particular by means of a rotary movement of the input element. The input element is preferably designed as an input wheel. The input wheel is in particular a finger roller or thumb roller or at least includes one.

The movability of the input element is in particular delayed (in particular damped) or held and in particular blocked if the currently displayed page information includes a previously set marker and/or a search term and/or a user reference. The user notice can include, for example, a prompt and/or a warning or the like.

In an advantageous embodiment, the input element is used for spreadsheet calculations and is preferably used. In this case, the mobility of the input element is preferably set as a function of at least one parameter of the cells in the table, preferably the content of the cells. The parameter can also affect the position of the table cells.

In particular, the movability of the input element when scrolling through a table is delayed and released depending on a displayed cell height and/or cell width and/or an actual cell height and/or cell width. It is provided that there is a grid for scrolling that corresponds to the cell height and/or cell width is set. In particular, the rotational movement of the input element is rasterized. In all of the configurations, the rastering takes place in particular by magnetorheologically generating stop points. In particular, the rasterization takes place through a targeted delaying or blocking and a targeted release of the movement at specific time intervals and/or at specific angles of rotation.

It is preferred and advantageous that the mobility of the input element is adjusted depending on an activity of a program running in the background and/or depending on an operating state of an operating system of the computer device. For example, mobility can be delayed or held and in particular blocked if the program in the background or the operating system issues a user notice and, for example, a prompt and/or a warning.

It is also advantageous and preferred that the movability of the input element is adjusted as a function of a zoom process. In particular, a different delay is set for zooming in than for zooming out. For example, there is a higher delay for zooming in than for zooming out, or vice versa. Advantageously, zooming in occurs with a delay along a movement direction. In this case, zooming out advantageously takes place in an opposite direction of movement with a different delay than for zooming in. Advantageously, the user receives direct haptic feedback about the zooming process.

In a particularly advantageous and preferred embodiment, the input element is used in a construction program and is preferably used. It is preferred that the mobility of the input element depending on a size and/or a priority of a processed by the input device and, e.g., moving component is set. It is possible and advantageous for an input into at least one input menu with inactive and active input fields for the mobility of the input element to be set depending on whether the input field is inactive or active. For example, mobility is blocked or at least partially delayed for inactive input fields.

It is possible and preferred for the mobility of the input element to be changed in a targeted manner in order to provide a haptic confirmation of an input that has taken place beforehand. Such a confirmation or such feedback can take place much quieter and more specifically with the invention than, for example, with a mechanically ratcheted mouse. In addition, many different confirmations can be made with the invention by appropriately adjusting the mobility. For example, the confirmation is made by the input element vibrating and/or rattling.

In this application, rattling is understood to mean, in particular, alternating blocking and releasing of the movability of the input element during an input or during a movement. The blocking and releasing takes place with a high frequency. A higher frequency can be provided for vibration than for chatter. For example, a frequency of at least 10 Hz or at least 50 Hz or at least 100 Hz or more is provided. Provision can be made for different types of confirmations to be provided depending on the level of the frequency.

In the event of an incorrect and/or implausible and/or critical input, the mobility of the input element is preferably delayed or held and in particular blocked. Such an input can also be acknowledged with the confirmation described above, for example by vibrating and/or rattling. Such configurations are particularly advantageous in the case of sensitive inputs or also in the case of medical devices. As a result, dangerous processes and, for example, critical machine movements or robot movements are prevented or displayed haptically to the user.

In an advantageous embodiment, it is provided that, after an input, the mobility of the input element is delayed or blocked until at least one further user input has taken place. The further user input takes place in particular through an input other than the delayed or fixed and in particular blocked mobility of the input element. For example, a pulling or pressing of the input element can be provided if the rotatability is delayed or held and, in particular, blocked. It is also possible that the further user input takes place by means of another input device. The further user input can, for example, relate to a confirmation of a particularly important or critical input.

In a likewise advantageous and preferred embodiment, the input device is used in gaming (computer games) and is used in particular. In this case, it is preferred that the mobility of the input element is set as a function of a scenario generated by the computer device. Preferably, the movability of the input element is delayed the more, the higher a force to be fictitiously applied in the scenario and/or the more difficult an action to be fictitiously performed in the scenario is. The delay is advantageously influenced continuously and in real time as a function of the input condition and in particular the movement parameter.

In all configurations it is possible that the mobility and preferably a grid of the rotatability of the input element can be adapted by at least one user input. The adjustment made is preferably stored in the computer device and/or in the input device. For example, the grid provided in the normal case can be coarsened and/or refined. It can also have a maximum Delay of mobility be adjustable. In particular, such an adaptation can take place specifically for a respective program.

In a particularly advantageous and preferred development, the input element includes at least one input wheel. The input wheel is designed in particular as a mouse wheel, in particular of a computer mouse. In this case, the input preferably takes place at least by turning the input wheel. Preferably, the rotatability of the input wheel can be deliberately delayed, in particular damped, and held, and in particular blocked and released, by means of the braking device. The input element, in particular the input wheel, preferably also has at least one axial mobility. For example, pushing and/or pulling the input element and preferably the input wheel can be provided.

In all possible configurations, it is particularly preferred that the movability of the input element can or is adjusted from freely movable to completely blocked. The ability to move or rotate within the scope of the present invention is completely blocked if a movement or rotation is not possible due to a force that can be generated manually during operational use of the input device. In particular, the braking device is suitable and designed to apply a deceleration torque of between 0.001 Nm (basic torque without deceleration) and 0.02 Nm (maximum deceleration), particularly in mouse wheel applications. In addition, it is also possible in other areas of application to apply deceleration torques of at least up to 0.5 Nm and preferably at least 2 Nm or at least 3 Nm. The basic torque and the maximum deceleration are advantageously dependent in particular on the design of the input device and the magnetorheological braking device.

It is preferred that the mobility of the input element and in particular the rotatability of the input wheel between freely rotatable and fixed and in particular blocked with a frequency of at least 10 Hz and preferably at least 50 Hz can or is switched over. A frequency of at least 20 Hz or at least 30 Hz or at least 40 Hz is also possible. A frequency of at least 60 Hz or at least 80 Hz or at least 100 Hz or around 1 kHz or an even higher frequency can also be provided. Frequencies of at least 120 Hz or at least 200 Hz or more are also possible.

For the rotatability of the input wheel, in particular at least 50 stop points and preferably at least 100 stop points can be set for each revolution. At least 150 or at least 200 or at least 250 or at least 300 attachment points are also possible. At least or at least 400 attachment points can also be provided. The minimum angle of rotation that can be set between two stop points is in particular a maximum of 10° 11 and preferably a maximum of 5° and particularly preferably a maximum of 2°. The minimum angle of rotation that can be set between two attachment points can also be a maximum of 1° or a maximum of 0.5° or a maximum of 0.1º.

The number of attachment points is preferably set as a function of a number of input options provided. For example, the number of anchor points is set depending on selection options, menu options and/or a number of pages or tabs or the like. In this case, a stop point is provided in particular by the fact that the rotatability of the input wheel is at least temporarily deliberately delayed and in particular blocked and then released again.

In at least one advantageous development, a vibration, i.e. a vibration, is used as a warning signal, i.e., in particular a ripple (vibration) is generated by the magnetorheological braking device with a frequency of more than 100 Hz, so that a haptic perception and a perceptible sound are generated by the magnetorheological braking device. The current flow and/or the voltage alternate between a positive (maximum) value, a zero value and a negative (maximum) value. The frequency of the warning signal can advantageously be between 50 Hz and 2 kHz or even higher up to 20 KHz. The current flow in the magnetorheological braking device is reversed, in particular periodically, so that the braking device vibrates and passes on the warning to the user. In addition, the braking device also generates an audible sound signal at such a high frequency. It can be advantageous not to place the alternating current signal and/or voltage signal symmetrically around the zero point, but rather to apply an offset. This changes, in particular, the perceived feeling of the user. In particular, audible frequencies are output by the braking device. When the input element moves, the vibration can be perceived, for example, by a finger and/or the user's hand. A vibration generated by the braking device is transmitted from a support body of the input element or the braking device, for example, to at least one housing of the input device, which is designed, for example, as a computer mouse. In this way, a shrinkage that is acoustically perceptible, preferably for a human, can be generated.

It is practically possible to generate a tone with the input element. The sound or audible fade may not only come from the braking device itself, but from the vibration of the housing and many or nearly all or all parts of the mouse.

In a specific embodiment, the vibration is passed on from the mounting of the mouse wheel or the brake to the housing of the mouse. The resulting vibration of the mouse body creates the acoustic sound.

If there is a ripple, the mobility of the input element may be blocked at least in sections. In addition, the mobility of the input element can also be partially delayed and/or partially fixed. In particular, superimpositions with other signals of the braking device are possible.

Voltages for operating the magnetorheological braking device are preferably generated by a random number generator, so that a torque and in particular a magnetic field strength quickly jumps back and forth between different strengths. As a result, the mobility of the input element can be adjusted as if, for example, sand were present on or in a bearing point or a bearing was badly worn. The voltage and current range of the random number generator can be varied. In a narrow area in particular, movement of the input element can then feel as if bearing friction is increased.

It is possible and advantageous for a rotation angle between the stop points to be reduced when scrolling and/or changing pages is faster. It is possible that a rotation angle between the stop points is increased when slower scrolling and/or slower page switching occurs. The reverse configuration is also possible.

In particular, the angle of rotation of the input wheel is monitored by means of a sensor device. The sensor device is particularly suitable and designed to detect the angle of rotation with a resolution of at least 1° and preferably at least 0.5° and particularly preferably at least 0.2° or also preferably at least 0.1° or better.

In all of the configurations, it is particularly preferred that the mobility of the input element can or is adjusted in real time. In particular, the braking device is suitable and designed to change the deceleration by at least 30% within less than 100 milliseconds. In particular, the delay can be changed within less than 10 milliseconds by at least 10%, preferably by at least 30% and particularly preferably by at least 50%. The delay can also be variable by at least 100% or 500% or by tens or thousands of times within less than 100 milliseconds. Such real-time control is of particular advantage when working with the input device.

It is possible that the input condition is also dynamically adapted depending on the input. This makes it possible for the movability of the input element to be adjusted according to the principle of feedback and in particular regulation by the input made. A particularly advantageous adaptation of the rotatability and thus a particularly intuitive operation of the input device is achieved by such a mutual dependence between the input and the input condition.

It is possible and preferred that the control of the mobility of the input element is designed to be capable of learning. In particular, at least one machine learning algorithm is stored for this purpose. For example, a user's habits with regard to the implementation of inputs while operating a program are recognized and stored in a memory device. For example, frequently used switching elements or menu items or the like can be recognized and stored. As a result, when the program is used again, the user can be supported by targeted control of the mobility of the input element.

In particular, the braking device comprises at least one field-sensitive magnetorheological medium and at least one field-generating device for generating and controlling a field strength. In particular, the mobility of the input element is specifically influenced by the field generating device and the medium. The input device according to the invention serves in particular to carry out at least one of the methods described above. The input device according to the invention also solves the above task in a particularly advantageous manner. In particular, the input device has the devices necessary for carrying out the method. In particular, the input device has at least those devices that were presented in the context of the description of the method according to the invention. In particular, the input device is suitable and designed to implement the previously described method using an algorithm stored in the input device and/or in the computer device.

A braking device that is particularly advantageous for use with the invention is also described in patent application DE 10 2017 111 031 A1. The entire disclosure of DE 17 10 2017 111 031 A1 is hereby part of the disclosure content of the present application.

In particular, the braking device has at least one wedge bearing and at least one coil arranged axially to the axis of rotation. As a result, the coil does not have to be placed next to the rollers of the wedge bearing, which means that the expansion in the axial direction can be kept smaller in the case of longer rollers. In particular, the input wheel is arranged radially around the wedge bearing.

The method according to the invention and the input device according to the invention are suitable for many applications, some of which are shown below as examples:

For example, an intelligent reading mode in connection with at least one computer device is possible. In this case, for example, an actuation of the input element zooms to an easily legible size and then, especially when rotating, always exactly as a human would read a passage of text. This means that at the end of the sentence the zoom jumps back to the beginning and so on. The writing always stays at the same height and preferably in the same reading area so that the eye does not have to jump back and forth.

In addition, the method and the input device are particularly suitable for accepting and rejecting calls by mobile phones and/or haptic phone cases. In the case of a call, a call can be accepted or rejected, in particular depending on the direction of rotation of an input element with a stop point. When rejecting the call, it is preferably possible to scroll through the input element through various messages, which are sent to the caller in particular by an actuation.

It is also conceivable to use the method and the input device for people with visual impairments and in particular blind people, who receive corresponding feedback in particular in the form of a haptic Morse code through the input device and preferably through the input element, which advantageously serves as an aid.

It is also conceivable to use the method according to the invention and the input device in a thumb roller. The braking device of the thumb roller can advantageously be designed as a horizontal wedge bearing. In particular, the design is very narrow.

In this case, the rolling elements are advantageously designed as cylindrical rollers. The rollers have a small diameter (e.g. 1 mm) and advantageously a larger axial extent (e.g. 5 mm). A magnetic coil can either be essentially horizontal (wound in the axial direction) or essentially in the radial direction (coil wound around the axis).

As also in particular with other actuators for haptic feedback, the thumb roller preferably also needs at least one sensor, which advantageously measures at least one rotational movement. For this purpose, in particular, at least one rotary encoder or also advantageously a magnetic ring with Hall sensor can be used. In principle, the same haptic feedback can advantageously be implemented with the thumb roller as is advantageous with other input devices, which can be implemented in particular as a rotary knob with at least one wedge bearing. Because of the advantageously small installation space, it is preferably not possible to generate such high torques. Experience has shown that this can be dispensed with in the case of a small diameter, or high torques can be of secondary importance.

The thumb roller can advantageously also have a push function (press and hold) in which the thumb roller is advantageously pressed. This can be used in particular to confirm a function and/or also to switch (on/off) and/or in particular also as a return function. Advantageously, any other function e.g., can be defined by the customer, such as, e.g., picking up or hanging up the call.

An input device, which is advantageously designed as a thumb roller, can also be used, for example, as a mechanical on/off switch (turning) and/or preferably also for picking up from the smartphone or for hanging up. Here, the method and the input device can achieve increased functional reliability in relation to incorrect operation compared to a slider or software switch.

In addition, applications are conceivable in which haptic feedback from an input device implemented as a mouse (or from a program) increases working speed and/or advantageously helps to avoid errors. This can be particularly advantageous for long lists, such as spreadsheet programs (e.g. Excel) and/or word processing programs (e.g. Word). There are many different advantageous use cases (individual use cases can be implemented individually or in any combination):
A scroll wheel as a control element stops short, especially at preferred points e.g., for important dates, totals, at the end of lists or chapters, for headings, in Word for words marked in red (especially misspelled) and/or at the end of files etc.
When using a search function, the cursor advantageously jumps to the next search result when scrolling with an input element. In particular, this speeds up searching for data in large lists and files.
Advantageously, a mouse wheel stops at cells that are assigned a function (e.g. programmed cells). In this way, it is possible in particular to prevent cells that have not been accidentally programmed from being deleted and assigned a number.
In addition, the application can also be beneficial for formatted cells. In particular, the pointer jumps to cells with the same formatting and/or advantageously stops at cells with a specific formatting.
In particular, when scrolling slowly through at least one operating element, it is advantageous to scroll only a little further in a file and, for example, more when scrolling quickly. In particular, this can be indicated by a larger grid when turning the mouse wheel as an input element.
Especially when scrolling through Excel lists, the grid points have a fixed cell spacing (adjustable) in order to get a good idea of the length of the list.
In particular, when scrolling through an Excel list, a pre-programmed “stop” or stop can be set for totals or certain important results.
The grid spacing changes in particular depending on the position in the file. In this way, navigation in a file can advantageously be simplified. E.g.: If the spacing of the grid becomes smaller in the vicinity of certain positions (new section, heading, totals, end, etc.), or an input element designed as a mouse wheel is more difficult to turn and thus indicates, for example, that you are approaching this area in particular. As a result, a user knows in particular before this position is reached that one is approaching it, for example, and not only when one encounters it in particular. This is particularly beneficial for people with visual impairments.
If several people are working on the same file (e.g. in Word), it is possible that errors can be avoided, especially with haptic feedback, since changes in particular are no longer overlooked so quickly. For example, a mouse wheel will stop when someone else makes changes, such as when scrolling through the file.
In the start menu of programs, in particular system programs of computer systems, for example, the most used programs are displayed as tiles further up. The adaptive mouse wheel can be used to slow down more with these programs in particular.

In addition, many possible advantages can be derived from an input device designed as a mouse with, in particular, bidirectional communication:
Error messages can be displayed haptically (example by any type of feedback, e.g. vibration)
In particular, events can be displayed, e.g. e-mail receipt etc.
In particular, when entering into a computer device, such as after clicking a button/link etc., the user advantageously receives feedback. This prevents a program from being opened multiple times, in particular if it does not open immediately or, for example, when sending an e-mail etc.
The mouse can also be used advantageously as a learning aid for new programs, tutorials and computers in general: A user receives at least haptic feedback if something is done wrong or right in the tutorial, for example. This makes it easier to get started with new programs in particular. A user may advantageously learn more easily if given feedback in some form in particular.
In addition, it is conceivable that a mouse as an input device learns itself: the software then remembers in particular movement patterns of the input element and uses this for advantageous internal derivation, in particular of control structures and commands (artificial intelligence).

In addition, the following applications in computer games/game applications are conceivable:
The user's habits and can be supported, advantageous when searching, in particular by a “stop” at frequently used buttons, links, etc.
It is also conceivable to include at least one vibration as an additional haptic response.

In addition, there are also possible and conceivable advantages in bidirectional communication with CAD programs:
In particular, easier catching thanks to haptic feedback, especially when a contour is reached, etc.
An advantageous error display in the case of unauthorized construction e.g. when surfaces or contours intersect, or when a hole goes too deep.
When setting values, for example, the scroll wheel stops when it reaches minimum and maximum values or impermissible values, etc.
When zooming, the resistance is advantageously not the same when enlarging as, in particular, when reducing.
In particular, the input device can be designed as a learning aid through haptic feedback.
For example, when moving large parts in particular with the mouse, a joystick, etc., there is more resistance.
The scroll wheel is advantageously slowed down, or in particular the resistance of the mouse on the surface (e.g. in particular by, for example, at least one ball on the underside (Databot mouse). For example, the size of parts can be advantageously felt.

In addition, there are also many advantages in gaming or computer games:
The resistance of the mouse wheel/joystick changes especially depending on the game situation. For example, when driving large vehicles, for example, resistance becomes larger.
The devices can, for example, be adapted to real systems (e.g. joystick of an airplane in the flight simulator: different types of airplanes have different resistances in the input device and especially in the joystick).
In particular, an additional response of the system through vibrations (ripples) is possible.
Soccer game: A resistance of the control increases especially when a user is in possession of the ball, for example.
Simulation (agriculture): The control changes in particular depending on the subsoil, e.g. earth, asphalt, sand and/or etc.
Car racing game: It can possibly be played with a steering wheel with at least one haptic feedback, in particular by at least one input device. In particular, a haptic thumbwheel can be present in the steering wheel, for example, to change radio stations. In particular, the control can also be changed depending on the surface. This can be particularly the case in a steering wheel application. In particular, a gear change with an input device is conceivable, which in particular comprises at least one movement of a thumb wheel and/or a scroll wheel.
In particular, use as a learning program for driving schools is possible and conceivable.
Handicap for good gamers: Good players receive in particular an input device that is more difficult to use, which is designed, for example, at least as a mouse and/or at least as an input device on the mouse. The haptic works in particular against the player, so that he has a particular disadvantage compared to inferior players. In this way, the “skills” of different players can be advantageously adapted to one another.

In addition, an advantageous use of the method and the input device is also conceivable for automobiles, in particular in the form of a thumb roller on the steering wheel or preferably a rotary pushbutton, which can also be associated with the following advantages:
Use the haptic thumbwheel to adjust radio stations in particular and/or advantageously adjust the volume.
In particular, the input device can be used to change over a clock, also advantageously mechanical clocks with, for example, the rotary pushbutton (advantageous like the setting wheel/crown in mechanical wristwatches), e.g., light increments for each minute, more resistance at five minutes, more at 10, 15, 30, and 60 minutes.
Intuitive application is also possible to simplify operation complexity, e.g. when making a call, the thumb roller can be used in particular to answer or reject the call first. Turning up decreases in particular, turning down hangs up advantageously and/or vice versa. This can be indicated in particular by e.g., with LED illuminated displays (“green”-remove: “up”; “red”-reject: “down”). In particular, if the user has accepted the call, the volume can advantageously be adjusted during the call, in particular using the same thumb wheel. The operation should advantageously be as simple and intuitive as possible. For this purpose, it is advantageous to work with changeable displays, either for example with displays (e.g. Oled display) or in particular with color displays with different colored LEDs (red and green as known colors for on/off; etc.).
It is also conceivable to change gears, change a driving mode, set a cruise control, set ACC (Adaptive Cruise Control) with a haptic input device, which is designed, for example, as a rotary knob or thumb roller.
In addition, the input device can be used for a faster phone book search: The thumbwheel can be used to scroll through the phone book in particular. Advantageously, for example when reaching a new letter or a letter that is being searched for, in particular an initial letter, a user can advantageously experience brief resistance. This can be advantageous because or if preferably one Voice control often does not immediately understand the correct name. Preferably at least one gesture control or the use of at least one touchpad and touch screen can often lead to wrong letters. With the thumbwheel you can find and/or search for the right name, for example, very accurately. In particular, with additional haptic help, the search is particularly simpler and advantageously faster. This can be particularly advantageous when used in vehicles, in particular in order not to be distracted from the road for a long time.

In addition, the following general advantages can also be realized as options:
A scroll wheel is particularly difficult to turn at the end of pages (stops advantageous), for example especially at the end of the view, advantageous at a zoom maximum/minimum, especially at the end of lists etc.
It is advantageously blocked, especially when visiting forbidden sites, e.g. as parental control on the Internet.
The grid of the scroll wheel can in particular be switched on and off and preferably at least one level of the grid can be changed in particular at the same time.
In particular, the user can advantageously set a grid width as desired.
It is conceivable that folder and file sizes can advantageously be displayed at least by a resistance when moving. In particular when scrolling through folders, the resistance can advantageously be greater in the case of large folders and/or advantageously smaller in particular in the case of small folders and individual files than, for example, a reference and/or preferably a preset standard value. At least one haptic feedback can be of great advantage for visually impaired people (in particular if the mouse pointer is no longer clearly visible because it is too small, for example).
The mouse wheel can, for example, preferably change a scrolling behavior when the cursor approaches a desired (favorite) point (or fixed points, at a constant distance, etc.).
In the case of entertainment media, it can be conceivable that the mouse wheel will advantageously stop when fast-forwarding and rewinding films, songs, etc., advantageously every five minutes, for example, with each new scene, at the beginning of the next song and/or in playlists for frequently heard songs, etc.
The resistance changes favorably when adjusting the volume. At volume “0”, i.e. in particular no volume, at least one input device stops in particular and if, for example, a level that is too high is reached. In particular, if there is at least one risk of hearing damage, the mouse wheel is particularly difficult to turn.
The same can also apply to screen brightness, for example. If the screen brightness is preferred, for example, a short resistance or a brief delay of the control element by the braking device can advantageously stop and/or also delay at least one movement.
Alternatively, for example, a haptic scroll wheel can be advantageously arranged at least on the keyboard, so that pages and documents etc. can be scrolled quickly, for example, without having to take your hand off the keyboard in particular. It can advantageously be designed both as a rotary knob and as a scroll wheel and/or as a thumb wheel. be that These input devices are advantageously controlled, for example, by a wedge bearing with an axial coil, or also advantageously by the classic wedge bearing, which in particular has a radial coil.
For example, the input device can also be used advantageously for switching through and in particular “switching through” through apps. In this case, there can be a higher resistance, in particular with preferred apps.
In particular, the input of music notes into music notation programs can be made much easier: For example, an input wheel can snap to every staff line.

The resistance is particularly high in the case of low tones and is advantageously lower in particular in the case of higher tones. In this way, the pitch on the mouse wheel is advantageously felt and one advantageously knows where one is in particular on the staff.
In drawing programs: The resistance of a movable input device changes advantageously when the settings are changed in particular: if, for example, the line thickness is increased with the mouse wheel, at least one resistance, for example of a mouse wheel, increases. Or in particular when zooming, the resistance is advantageously greater when enlarging a view than in particular when reducing.
Advantageously, when searching on the Internet or using a search engine, for example, scrolling can become increasingly difficult the further away you are from an original search query. For example, it is at least haptically noticeable when you are preferably near unlikely hits.
In particular, when programming, it can be advantageous for a grid to adapt advantageously to a syntax, i.e. advantageously adapts or is oriented towards at least one programming language. For example, it can advantageously stop at a loop start and/or end or there can be a short resistance, for example.
Advantageously, for example, in e-mail programs, at least one mouse wheel can stop in particular: in particular with every unopened e-mail, with e-mails with attachments, with e-mails that have been replied to and/or with e-mails with a higher priority, etc.
Advantageously, different modes can be programmed, so that each user can advantageously implement his own ideas. For this purpose, for example, a simple app can be implemented to adjust individual haptic feedback.
In particular, the strength of the mouse wheel resistance can advantageously be adjusted by pressing the mouse wheel: if, for example, a mouse wheel is preferably pressed, a menu is called up in particular, in order to be able to set the strength of the resistance, for example.
A scroll wheel according to the invention can advantageously also be used on mobile phones or other mobile devices. For example, the volume on the cell phone can be changed without having to look at the touchscreen.
In addition, use with game consoles is conceivable.

The invention makes it possible to provide a virtual freewheel or a simulated freewheel state via internal or external software or via a controller programmed into or included in the input device.

The freewheel state can be controlled within the input device. The control of the freewheel state can take place outside of the input device. In particular, the freewheeling state can be controlled in an assigned computer.

In the case of a computer mouse, freewheeling means that the mouse wheel continues to turn without external force after it has been set in motion (by the finger). The finger is removed from the mouse wheel and placed back on the mouse wheel when the freewheel is to stop. Such a “real” freewheel requires a certain amount of energy and smooth running of the mouse wheel and thus low basic friction.

With a real idle state or a simulated idle state, it is possible to scroll through the list in a (very) long list/document so quickly. With real freewheeling, a heavy mouse wheel (e.g. made of metal) results in longer real freewheeling.

Mouse wheels that can be controlled and braked in a targeted manner can, due to internal friction, also with relatively high energy input (by a quick finger movement-a quick nudge/give momentum) cannot be put into free rotation for very long.

With a magnetorheological brake, freewheeling can be achieved over a few revolutions if the basic friction is low or the basic friction is reduced. This facilitates the implementation of a simulated freewheeling state.

The freewheel state is simulated in particular by the software and is not a “real” (physical) freewheel. For example, the mouse wheel is turned by the user and the software interprets this as continuous turning/scrolling until the user stops For example, touch the mouse wheel again and thus stop the (virtual) freewheel, although in reality the mouse wheel can already be stationary again.

The simulated freewheeling state can be activated in particular via:
by activation via a button or switch
or by exceeding a specific (rotational) speed/angular speed, i.e., for example, beyond a threshold value
or by exceeding a certain acceleration
or the system recognizes this independently (artificial intelligence; machine learning)
or by a gesture, e.g., a camera looks at the user
or by an acoustic command from the user
or by a swipe gesture by the user on e.g. a touchpad,
or by a keyboard command, or a menu entry, or by an automatic start command.

An input device that can be actively braked then switched in particular to idle or to the smallest possible damping, so that the input element (such as a mouse wheel, for example) experiences only minimal braking (basic friction).

For example, if the user rotates a mouse wheel, the maximum speed reached (simulated in the output) is maintained or slowly reduced in software, possibly via a defined or adjustable reduction curve.

In particular, the simulated freewheeling state is exited again when the user touches the input element (e.g. the mouse wheel) again. The touch can for example be recognized via:
the encoder signal (the acceleration at the rotation angle sensor; change in the angle of the mouse wheel)
Optical (camera, environmental sensors)
Capacitive.

The sensor device or a rotary encoder of the sensor device is in particular so high-resolution that the smallest movement can be measured. The user doesn't even notice that he is turning the mouse wheel by a small angle when he puts his finger on the mouse wheel (again). Tiny movements that come from vibrations from other sources have to be filtered out.

The use of magnetorheological braking devices in input devices then offers the advantage that the sensor device therein usually has a sufficiently high resolution, in particular if ticks (ripples) are to be generated adaptively. To stop the freewheeling state, a direction reversal e.g., the mouse wheel is not necessary.

The user's finger must be regularly lifted from the mouse wheel in the freewheel state or to activate such a state. But this is also the case with a “real” freewheel, because with a real freewheel the finger must not linger on the mouse wheel, otherwise the finger would brake it.

For example, if the mouse wheel on a control device turns quickly and the damping force of an actively braked mouse wheel is switched to minimal, the user usually does not even notice that the mouse wheel is being braked by the friction if he does not keep his finger on it or constantly presses the mouse wheel looks.

First tests with a registered input device worked well.

The optical or acoustic feedback to the user (even if not necessary in the standard use case) can possibly also be simulated by the integrated LEDs in the computer mice and thus simulate a mechanical rotation (“thread” between e.g. two LEDs). or in a similar way). A virtual and simulated idle state is also useful for other applications, i.e. not only for the mouse wheel, but also for rotary/push controls, haptic buttons, side mouse wheels, thumb rollers, e.g., in the steering wheel of an automobile or with a thumb roller in a case of a smartphone or on a thumb roller on a smartphone.

In a preferred development, the input device or the operating device includes a control device which is suitable and designed to brake the rotational movement of the operating part by means of the in particular magnetorheological braking device as a function of an operating state of a motor vehicle. The operating state preferably includes at least one driving mode and at least one stationary mode. The stationary operation includes in particular at least one charging operation for a traction battery of an at least partially electrically operated vehicle.

In particular, the control device is suitable and designed to select and set or propose a functional level, which can be operated with the control panel, automatically and preferably using a machine learning algorithm, depending on the operating state. In particular, the function level includes at least one entertainment function. In particular, the entertainment function is selected depending on the stand operation. In particular, the functional level includes at least one driver assistance function. In particular, the driving assistance function is selected depending on the driving operation.

It is preferred and advantageous that the control device is suitable and designed to automatically block and/or not suggest a functional level depending on the operating state and preferably using the machine learning algorithm. In particular, depending on the driving operation, those functional levels are specifically blocked and/or not suggested which are suitable for distracting the driver and/or which are legally prohibited while driving. In particular, it can be stored in the control device which functional levels should be blocked and/or not suggested.

Such further developments can be carried out purely by way of example as follows (in this case individual features can also be implemented individually or in any combination with one another): Electric/hybrid vehicles require more time to refuel (charge) than internal combustion engine vehicles. Depending on the charging structure and battery size, this can be several hours. Even with fast charging stations (800 volts), charging takes noticeably longer than refueling with fossil fuel. A motor vehicle is equipped with many operating elements which are designed at least in part like the operating part described here. During the charging process (stationary operation), the adaptive (magnetorheological) controls in the vehicle are haptically controlled in such a way that the driver can use them to pass the time or work (adjustment of entertainment functions). The car and the controls then become an office or a gaming station. For example, a control panel designed as a rotary wheel or thumb roller in the steering wheel or in the center console can be used as a computer mouse wheel, the head-up display, dashboard display or other (touch) displays can be used as a display unit, the lighting can be used to create effects and the voice input can be used for e.g. texts to dictate. Even a multifunctional seat (its massage function) or the chassis can be included (e.g. air suspension from a car or truck) and to recreate certain game states more realistically. The blinker, gear lever, (shift) paddles/pedals to control in games, the (by wire) pedals to control a car in a gaming game (e.g. Need for Speed . . . ), and the steering wheel, especially in cars with steer by wire, or all together as Flight Simulator Operation/Game. For this purpose, the haptic (force feedback), i.e. the force over the distance or the torque over the angle, must be set variably according to the requirements and be adjusted (in particular by the control device, which specifically controls the braking device). The haptic feedback of the thumb roller in the steering wheel is expanded so that e.g. in connection with an office application (PC) it is easier to scroll through pages, a brief increase in force on the user finger is noticeable when the page breaks. The scroll wheel becomes harder to turn (stops) at the end of pages, end of view, zoom max/min, end of lists etc. It is blocked when you visit forbidden sites (e.g. as parental control on the Internet). The grid of the input wheel can be switched on and off and the strength of the grid can be changed. The user can set the grid width as desired. File folder and file sizes are indicated by more drag when moving. When scrolling through folders, the resistance is greater for large folders and less for small and individual files. The thumb roller, which becomes a mouse wheel, can change its scrolling behavior when the cursor approaches a desired (favorite) point (or fixed points, at a constant distance, etc.). If the mouse wheel is used for gaming, the torque should generally be reduced (e.g. <1 mNm, because the adaptive wheel is used for much longer than for setting a menu when driving, so it is more strenuous. When driving, or in the driving operation, the controls should be a little heavier (higher torque or force; e.g. 2 mNm), as the vehicle is exposed to vibrations and driving is a dynamic process (forces act from outside). When stationary or when charging the battery is an overall static process in which the control element is used for a long time and intensively, but in a quiet environment very intensive input sometimes leads to inflammation (e.g. tendonitis). In addition, in games or office applications, the torque must be varied more finely and in more stages (more diversely) and with different tactile curves than when operating the car. The modes can be programmed, especially when used as a non-driving-specific control element, so that every user can implement their own ideas. A simple app for adjusting individual haptic feedback can be implemented for this purpose. The haptics in the vehicle can also be taken over from the game console at home or the PC in the office (e.g. settings are stored and taken over in the cloud). However, the haptic should return to a standard mode for driving-specific inputs so that the vehicle driver receives reproducible feedback for driving events, especially if these are safety-relevant (e.g. cruise control, distance control, accelerator, brake . . . ). The above is also beneficial for the rear seats in the car. There, too, the adaptive rotary controls for the ventilation or the input devices for the air conditioning can be used haptically as input devices for playing. For example, children can use the multifunctional control elements that are already available when charging the battery or while driving and thus pass the time. The vehicle can also be used in the garage as a “game simulator” or as a “driving school simulator”, it doesn't just have to be when charging the battery. Such designs can also be used for other vehicles such as trucks, off-highway vehicles, motorcycles, snow groomers, airplanes, bicycles . . . , that is, vehicles that have operating elements that can be adaptively adjusted.

The applicant reserves the right to claim an input device that is suitable and designed to be operated according to the method described here.

Further advantages and features of the present invention result from the description of the exemplary embodiments, which are explained below with reference to the attached figures.

In the figures show:

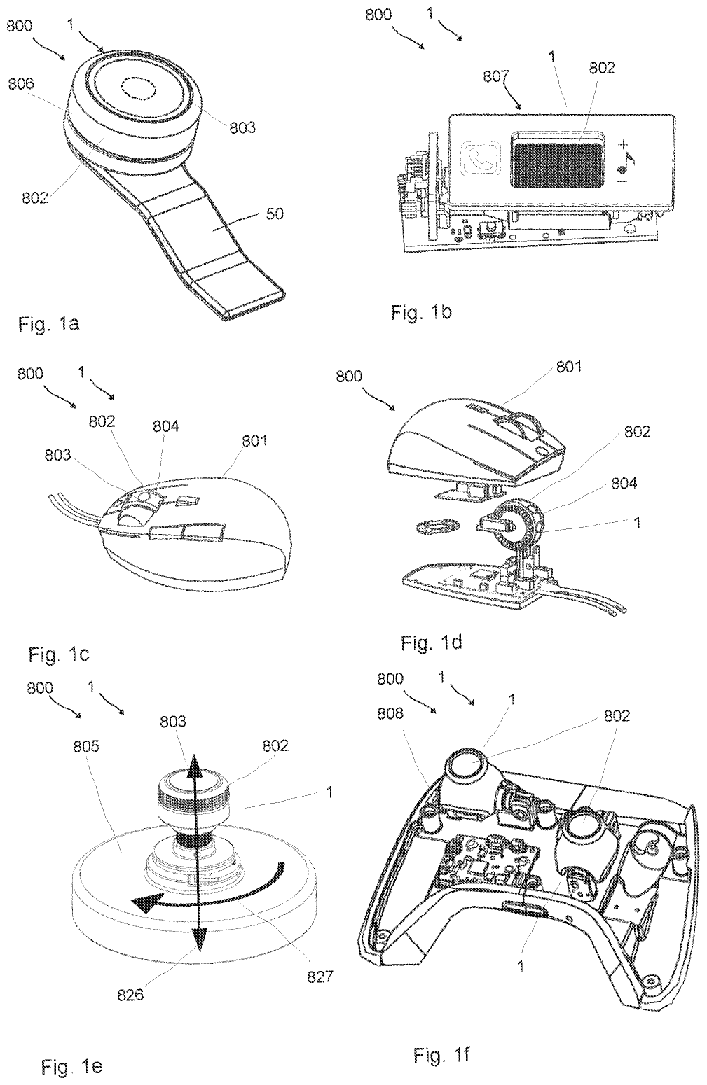

FIGS. 1a-1f show purely schematic three-dimensional views of input devices according to the invention;

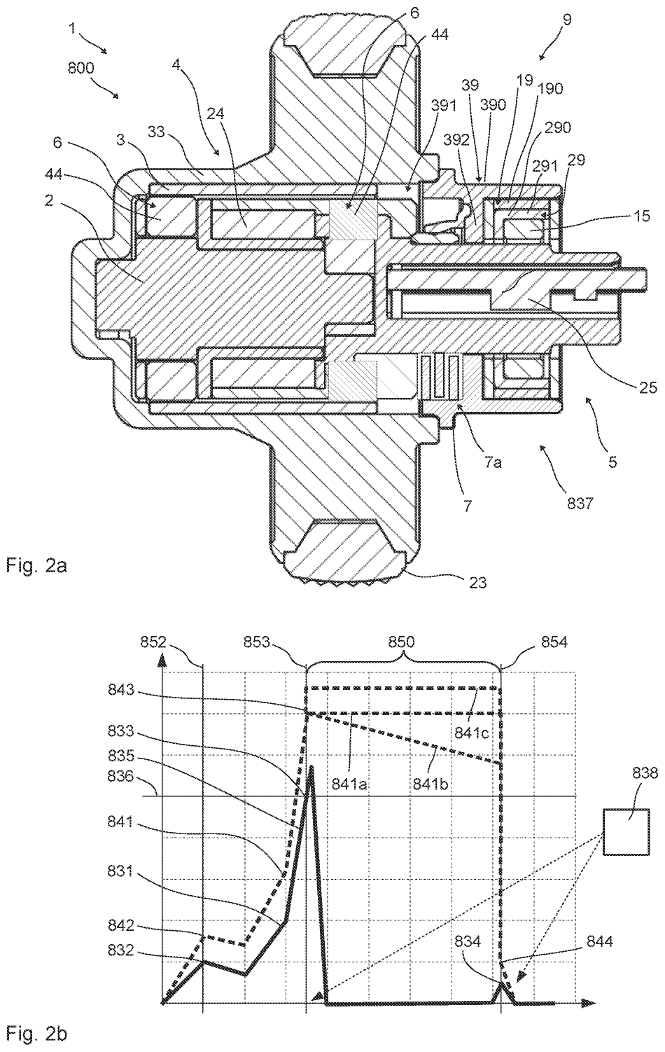

FIG. 2a shows a purely schematic representation of a braking device in a sectional side view;

FIG. 2b shows a purely schematic representation of the movement speed of an input element and the derived signal s over time;

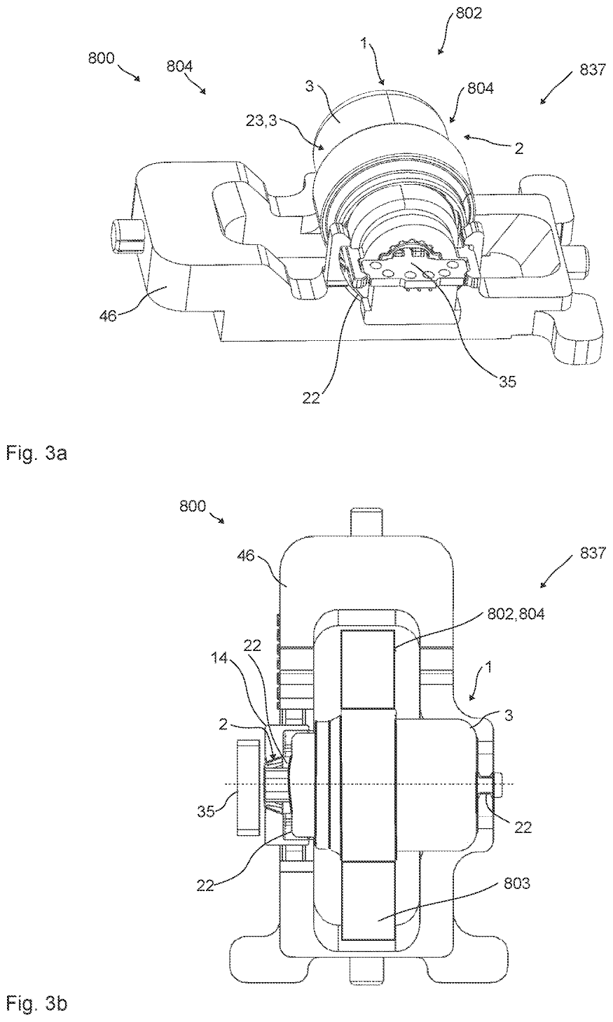

FIGS. 3a, b show a purely schematic perspective representation and a top view of a braking device for a mouse wheel as an input element of a computer mouse according to the invention as an input device;

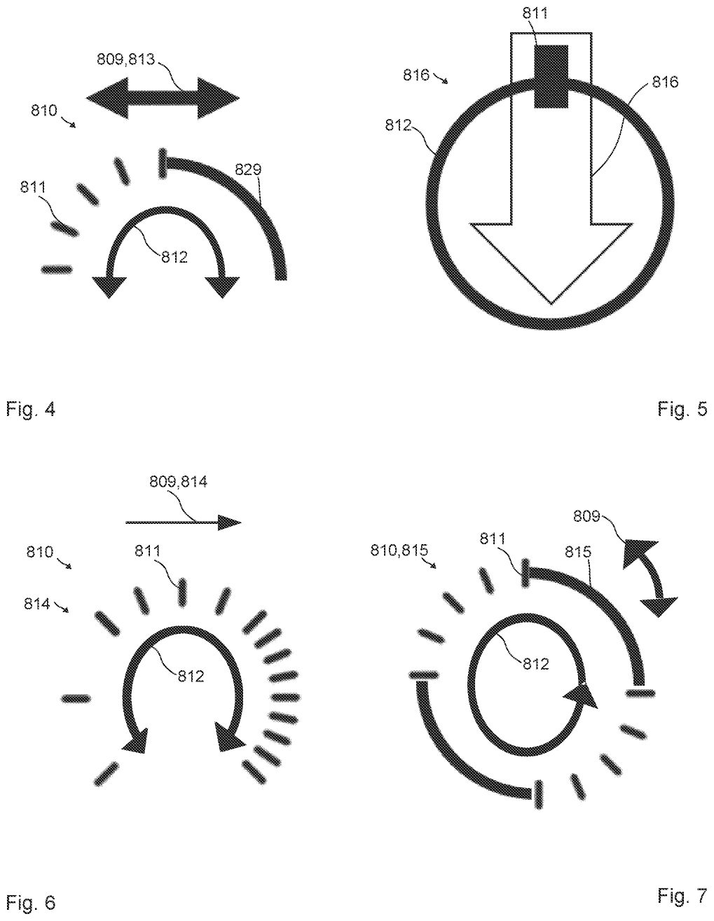

FIG. 4 shows a purely schematic representation of a haptic mode with a detent of the range of motion by the magnetorheological braking device and direction-dependent idling;

FIG. 5 shows a purely schematic representation of a further haptic mode with a blocked position of the mobility of the input element by the magnetorheological braking device when the input element is pressed;

FIG. 6 shows a purely schematic representation of a haptic mode of a speed-dependent detent within the range of movement of the input element by the magneto-rheological braking device;

FIG. 7 shows a purely schematic representation of a haptic mode with a grid within the range of movement of the input element, in which individual grid points are skipped;

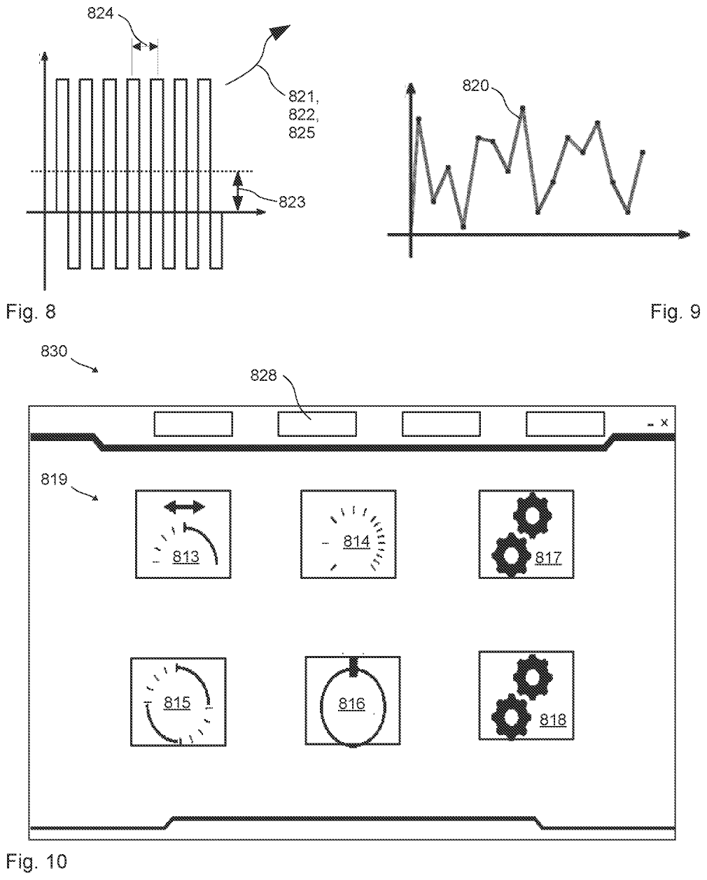

FIGS. 8, 9 show a purely schematic representation of a haptic mode of a warning signal with a high frequency and a random current profile s for controlling the mobility of the input element; and

FIG. 10 shows a purely schematic representation of a user interface with a profile for controlling the mobility of an input element of an input device, which contains a large number of variable input conditions.

In the FIGS. 1a to 1f show input devices 800 according to the invention, which are equipped with magnetorheological braking devices 1 and are operated according to the method according to the invention. The input devices 800 here have input elements 802 designed as input wheels 803.

FIG. 1a shows an input device 800 designed as an operating button 806. FIG. 1b shows an input device 800 designed as a thumb roller 807. FIGS. 1c and 1d show an input device 800 designed as a computer mouse 801. The input wheel 803 is designed as a mouse wheel 804 here. FIG. 1e shows an input device 800 embodied as a joystick 805. FIG. 1f shows an input device 800 embodied as a gamepad 808. A linear movement 826 and a pivoting movement 827 are additionally identified in FIG. 1e.

FIG. 2a shows a braking device 1 of an input device 800 according to the invention with a rotary body 3 as an input element 802 for setting inputs. The operation takes place here at least by rotating the rotary body 3.

The rotary body 3 is rotatably mounted on an axle unit 2 by means of a bearing device 22 not shown in detail here. The rotary body 3 can also be rotatably mounted on an axle unit 2 by means of a wedge bearing device 6 designed here as a roller bearing. However, the wedge bearing device 6 is preferably not, or only partially, provided for the mounting of the rotary body 3 on the axle unit, but is used for the braking device 4 presented below. The rolling bodies serve here as braking bodies 44.

The axle unit 2 can be attached to an object to be operated and be mounted for example in an interior of a motor vehicle or on a medical device or smart device. For this purpose, the axle unit 2 can have assembly means that are not shown in detail here.

It can be provided here or in the following embodiments that the rotary body 3 can also be displaced in the longitudinal direction or along the axis of rotation on the axle unit 2. Operation is then carried out by turning, pressing and/or pulling or moving the rotary knob 3.

The rotary body 3 is designed here like a sleeve and comprises a cylindrical wall and an end wall connected to it in one piece. The axle unit 2 protrudes from an open end face of the rotary body 3.

The finger roller 23 can be equipped with an additional part 33 indicated here by dashed lines. This results in an increase in diameter, so that the ability to rotate is made easier, for example in the case of a wheel on a computer mouse or game controller that can be rotated with one finger, or a rotary wheel on a computer keyboard thumb roller.

The rotary movement of the rotary knob 3 is damped here by a magnetorheological braking device 4 arranged in a receiving space 13 inside the rotary knob 3. The braking device 4 uses a coil unit 24 to generate a magnetic field which acts on a magnetorheological medium 34 located in the receiving space 13. This leads to a local and strong crosslinking of magnetically polarizable particles in the medium 34. The braking device 4 thus enables a targeted deceleration and even a complete blocking of the rotational movement. So can be done with the braking device 4 haptic feedback during the rotation of the rotating body 3, for example, by a correspondingly perceptible grid or through dynamically adjustable stops.

The medium here is a magnetorheological fluid, which for example, as a carrier liquid includes an oil in which ferromagnetic particles 19 are present. Glycol, grease, silicone, water, wax, and thick or thin materials can also be used as the carrier medium but are not limited to these. The carrier medium can also be gaseous and/or a gas mixture (e.g., air or ambient air) or the carrier medium can be dispensed with (vacuum, nitrogen or air and e.g., ambient air). In this case, only particles that can be influenced by the magnetic field (e.g., carbonyl iron) are filled into the receiving space or active gap. A mixture with other-preferably with lubricating properties-particles such as graphite, molybdenum, plastic particles, polymeric materials are possible. It can also be a combination of the materials mentioned (e.g., carbonyl iron powder mixed with graphite and air as the carrier medium). As a carbonyl iron powder without a (liquid) carrier medium, the powder with the designation CIP ER from BASF can be used, for example, with a minimum proportion of iron of 97%, without coating and an average size of the particles of 5 Ipm, or the CIP SQ-R from BASF with at least 98.5% iron content, 4.5 pm average size and SiO2 coating. The various powders differ in the size distribution of the particles, in the coating, in the particle shape, etc.

The ferromagnetic or ferrimagnetic particles 19 are preferably carbonyl iron powder with spherical microparticles, the size distribution and shape of the particles depending on the specific application. A particle size distribution of between one and twenty micrometers is specifically preferred, although smaller (<1 micrometer) to very small (a few nanometers, typically 5 to 10 nanometers) or larger particles of twenty, thirty, forty and fifty micrometers are also possible. Depending on the application, the particle size can also become significantly larger and even reach the millimeter range (particle balls). The particles can also have a special coating/mantle (titanium coating, ceramic, carbon mantle, polymer coating, etc.) so that they can better withstand or stabilize the high pressure loads that occur depending on the application. The particles can also have a coating against corrosion or electrical conduction. For this application, the magnetorheological particles can be made not only from carbonyl iron powder (pure iron; iron pentacarbonyl), but e.g., also made of special iron (harder steel) or other special materials (magnetite, cobalt . . . ), or a combination thereof. Low hysteresis superparamagnetic particles are also possible and advantageous.

In order to supply and control the coil unit 24, the braking device 4 here includes an electrical connection 14, which is designed, for example, in the form of a printed circuit board or printed circuit board or as a cable line. The connection line 11 extends here through a bore 12 running in the longitudinal direction of the axle unit 2.

The receiving space 13 is sealed off from the outside here with a sealing device 7 and a sealing unit 17 in order to prevent the medium 34 from escaping. The sealing device 7 closes the open end face of the rotating body 3. A second sealing part 37 rests against the axle unit 3. The sealing parts 27, 37 are fastened here to a support structure designed as a wall 8.

The sealing unit 17 is designed here as an O-ring and surrounds the axle unit 3 radially. The sealing unit 17 abuts against the axle unit 2 and the rotating body 3. As a result, the part of the receiving space 13 filled with the medium 34 is sealed off from another part of the receiving space 13.

It is also possible, as the lower half of FIG. 2a shows, that e.g., instead of a touching seal 7 (upper half of FIG. 2a), a labyrinth seal 7a is used. This is particularly advantageous if a liquid magnetorheological medium with a carrier liquid is not used, but a powdery magnetorheological medium. Then a simple and in particular multiple deflection of a thin sealing gap is usually sufficient for an adequate sealing effect. With a dry, powdery magnetorheological medium, the basic friction can be reduced and a very low basic friction can be achieved, so that the input element such as e.g., a mouse wheel is possible after releasing. This simplifies the simulation of a freewheeling condition.

A sensor device 5 is provided here in order to monitor the rotational position of the rotary body 3 and to be able to use it to control the braking device 4. The sensor device 5 comprises a magnetic ring unit 15 and a magnetic field sensor 25.

The magnetic ring unit 15 is diametrically polarized here and has a north pole and a south pole. The magnetic field sensor 25 embodied here as a Hall sensor measures the magnetic field emanating from the magnetic ring unit 15 and thus enables the angle of rotation to be reliably determined.

In addition, the magnetic field sensor 25 is preferably three-dimensional here, so that in addition to the rotation, an axial displacement of the rotary body 3 relative to the axle unit 2 can also be measured. As a result, both the rotation and a push button function, or the pressing and blocking 816 (push/pull) can be measured simultaneously with the same sensor 25. The braking device 1 can, for example, also only be equipped with a rotating function and/or a pressing function.

The sensor device 5 is particularly advantageously integrated into the braking device 1. For this purpose, the sensor 25 is inserted here into the bore 12 of the axle unit 2. The magnetic ring unit 15 surrounds the sensor 25 radially and is attached to the rotary body 3. This has the advantage that not length tolerances, but only precisely manufactured diameter tolerances come into play. The radial bearing clearance between the rotating rotary body 3 and the stationary axle unit 2 is correspondingly small and can also be easily controlled in series production.

A further advantage is that axial movements or displacements between the rotary body 3 and the axle unit 2 do not adversely affect the sensor signal because the measurement is in the radial direction and the radial distance is essentially decisive for the quality of the measurement signal.

Another advantage is that the arrangement shown here is particularly insensitive to dirt and liquids because the sensor is located on the inside. In addition, the sensor can be encapsulated in the bore 12 with a plastic, for example.

The braking device 1 is equipped with a shielding device 9 for shielding the sensor device 5 from the magnetic field of the coil unit 24 of the braking device 4. The braking device 1 shown here differs from the braking devices 1 described above, in addition to the shielding device 9, in particular also in the design of the rotary body 3 and the additional part 33. The braking device shown here is, for example, a mouse wheel 804 of a computer mouse 801.

The rotary body 3 is designed here as a cylindrical sleeve and is completely surrounded by the additional part 33 on its outside. In this case, the additional part closes off the rotary body on that radial end face which faces away from the magnetic ring unit 15.

The additional part 33 has a radially circumferential elevation with a significantly enlarged diameter. This makes the braking device 1 shown here particularly suitable as a mouse wheel 804 of a computer mouse 801 or the like. The elevation is designed here with a groove into which a particularly non-slip material and e.g., rubber is embedded.

The braking device 1 shown here has two wedge bearing devices 6 spaced apart from one another. The wedge bearing devices 6 are each equipped with a plurality of brake bodies 44 arranged radially around the axle unit 2. The coil unit 24 is arranged between the wedge bearing devices 6. The braking bodies 44 are here, for example, rolling bodies which roll on the inside of the rotating body 3 or the outside of the axle unit 2.

The magnetic ring unit 15 is coupled to the rotary body 3 in a rotationally fixed manner, so that the magnetic ring unit 15 is also rotated when the rotary body 3 rotates. The magnetic field sensor 25 is inserted into the bore 12 of the axle unit 2 here. The magnetic ring unit 15 surrounds the sensor 25 radially and is arranged axially at the end. The magnetic field sensor 25 is arranged here with an axial offset to the axial center of the magnet ring unit 15. This results in a particularly high-resolution and reproducible sensing and in particular a detection of the axial position of the rotary body 3 in relation to the axle unit 2.

The shielding device 9 comprises a shielding body 19 embodied here as a shielding ring 190. The shielding device 9 also comprises a separating unit 29, which is provided here by a gap 290 filled with a filling medium 291. In addition, the shielding device 9 includes a magnetic decoupling device 39 which is provided here by a decoupling sleeve 390 and a decoupling gap 391.

The decoupling sleeve 190 here comprises an axial wall 392 on which the sealing device 7 is arranged. In addition, a bearing device 22 (not shown in detail here) can be arranged on the axial wall 392.

From the shielding body 19 is equipped here with an L-shaped cross-section and made of a particularly magnetically conductive material manufactured. From the shielding body 19 surrounds the magnet ring unit 15 on its radial outside and on its axial side facing the coil unit 24. For magnetic decoupling, the gap 290 is arranged between the shielding body 19 and the magnetic ring unit 15 and is filled with a filling medium 291. In this case, the filling medium 291 has a particularly low magnetic conductivity. In addition, the magnetic ring unit 15 is attached to the shielding body 19 via the filling medium 291.

A magnetic decoupling is achieved between the rotary body 3 and the shielding body 19 by the decoupling device 39. For this purpose, the decoupling sleeve 390 and a filling medium arranged in the decoupling gap 391 also have a particularly low magnetic conductivity. The decoupling sleeve 391 is here non-rotatably connected to the shielding body 19 and the additional part 33 and the rotating body 3.

In order to be able to decouple the rotating body 3 even better from the sensor device 5, the rotating body 3 is arranged here at an axial distance from the decoupling sleeve 390. The end of the rotary body 3 which faces the magnetic ring unit 15 does not protrude beyond the braking body 44. In addition, the rotary body 3 is set back or shortened axially in relation to the additional part 33. This results in a particularly advantageous magnetic and spatial separation of rotary body 3 and decoupling sleeve 390 in a very small space.

Since the magnetic field of the coil unit 24 for the braking effect flows via the rotary body 3, such a configuration offers particularly good shielding. So that this magnetic flux affects the sensor 25 as little as possible, the rotating body 3 is terminated earlier in the axial direction and the magnetically non-conductive additional part 33 takes over the constructive functions (bearing point, sealing points . . . ). As a result, the distance to the sensor 25 is also greater and the assembly becomes lighter overall. The rotary body 3 is made of a particularly magnetically conductive material. The additional part 33 and the decoupling sleeve 390, on the other hand, are made of a magnetically non-conductive material. The shielding body 19 and the rotating body 3 are made of a p-metal, for example. The components described here as magnetically non-conductive are made, for example, of plastic and have a relative magnetic permeability of less than 10.

The problematic fields, which can usually interfere with the measurement of the angle of rotation, are primarily the fields in the radial direction. These fields are shielded here with a shielding body 19 acting as a coat from a suitable material, e.g., magnetically conductive steel. In addition, the magnetic field of the magnetic ring unit 15 can be further strengthened. As a result, the magnetic ring unit 15 can be dimensioned smaller (thinner) and thus material, construction volume and production costs can be saved.

The construction is also improved in that the wall thickness of the shielding body 19 is varied and a gap 290 is provided between the magnet ring unit 15 and the shielding body 19. Through the gap 290 between the ring 15 and the shielding body 19, the shielding and the reinforcement can be optimally adjusted. The material of the shielding body 19 is selected here so that it does not go into magnetic saturation, so that external magnetic fields are adequately shielded (material in saturation lets magnetic fields through like air, i.e., with the magnetic field constant pO). With an advantageous design of the gap 290 between the ring 15 and the shielding body 19, the magnetic field does not close too much over the shielding body 19 and the field in the center of the sensor 25 is sufficiently homogeneous and is increased compared to a ring 15 of the same or larger size without a shielding body 19.

The dimensioning of the shielding device 9 shown here is particularly well suited for a mouse wheel 804 of a computer mouse 801 and has the following dimensions, for example. The shielding ring 190 is 0.5 mm thick, the distance between shielding ring and ring 15 is also 0.5 mm, the width of ring 15 is 2 mm and the diameter of ring is 8 mm. In this case, the possible interference field from the coil unit 24 is 140 pT, which results in a possible error in the angle measurement of 0.1° (cf. earth's magnetic field: approx. 48 pT in Europe).

FIG. 2b shows a highly schematic representation of the course of the movement speed or rotational speed 831 and the signal 841 over time in a simple example. The user first touches the stationary input element 802 and starts rotating the input element 802. At the point in time 852, a rotational speed 832 is determined and a signal 842 that is functionally (e.g., linearly) dependent thereon is output. As the user spins the input element 802 faster, the signal increases or the corresponding output increases. If the user rotates the input element 802 more slowly again, the signal decreases or the corresponding output decreases.

Here, the user accelerates the rotational movement significantly after a short reduction and, with the rotational speed 833 or acceleration, at time 853 exceeds the predetermined amount 836. To be precise, a characteristic value 835 derived from the change in the angular positions exceeds the predetermined amount 836 at time 853.

This triggers the start command for the freewheeling state. The time 853 thus becomes the starting time 853 of the simulation of the freewheeling state. From this starting time 853 until the simulation of the freewheeling state 850 is completed, a signal 843 is output, which no longer depends on the current position of the input element 802.

Basically, the input element 802 can run on more or less after being pushed by the finger. The output or derived signal 843 is independent of this. In simple cases, a high value can be set as signal 843 and remain constant over time (curve 841a). It is also possible that the signal is reduced over time (curve 841b). The reduction over time can be based on empirical values or can be reduced linearly, quadratically, exponentially or in stages. It is also possible that the signal is increased at the beginning of the freewheeling state 850 and is thus set higher than it is at the rotational speed (or acceleration) at the start of the freewheeling state 850. This is shown by the curve 841cm, which is constant here during the duration of the freewheeling state 850 but can also be non-linear. At time 853 there is a vertical jump to a higher value than would be expected.

The signal and thus the speed of the virtual scrolling can also be as fast as the maximum speed at which the user turns the input element 802 in the idle state. The signal (and thus the scrolling speed) can also exceed the speed and is therefore not limited to the mechanically possible turning speed. An artificial intelligence or the software in the input device or the associated computer can also recognize if this is desired. For example, if a list you want to scroll through is very long and the probability that you want to scroll longer passages increases as a result.

The end time 854 can be predefined, e.g., a predetermined period of time after the start time 853 or continue indefinitely.

It is also possible and preferred that the simulation of the freewheeling state 850 is ended when the user presses a button or a switch or, e.g., pressing a mouse button or issuing a gesture or a voice command. Likewise, the start time 853 can also be triggered via a separate button 838 or a voice command, a gesture or the like, or automatically. FIG. 2b shows representative dashed arrows from the button or switch 838 to the start time 853 and the end time 854.

It is also possible and preferred that the end time 854 is then determined and the freewheeling state is ended at the end time 854, at which a conscious change in the movement state of the input element 802 is determined. This can be the case, for example, if the input element 802 no longer rotates and the user rotates it by an angle (even a small one) by touching the input element 802.

It is also possible to determine the end time 854 if the input element 802 is (still) rotating and is being actively accelerated or decelerated by the user. An “active” intervention by the user can be detected by comparing it with the previous course of movement. Acceleration cannot usually happen by itself. Braking over the average of a short period of time also does not happen by itself. Special features of the system can be taken into account as empirical values.

To determine the characteristic value 835, the pivoting or rotational speed and/or the acceleration etc. can be taken into account.

A further exemplary embodiment of an input device 800 according to the invention is shown in FIGS. 3a and 3b. The input device 800 according to the invention shown here has a very small design and is particularly suitable for use in connection with a computer mouse 801.

FIG. 3a shows a perspective view here, while FIG. 3b shows a plan view of the same exemplary embodiment. The input element 802 is formed here by an input wheel 803 on which the mouse wheel 804 is arranged. The input element 802 is designed as a finger roller 23 here.

The axle unit 2 is here mounted and supported on the outside of the rotating body 3 of the mouse wheel 804 by bearing devices 22. A particularly small design is possible here, which is accommodated on the support body 46.

The controllable magnetorheological braking device 1 is connected in particular to a computer device (not shown) via the guide plate 35. The mobility of the mouse wheel 804 is controlled and influenced by the magnetorheological braking device 1. At the same time, the mouse wheel 804 continues to serve as an input element 802 for the computer device. Depending on an input condition, the mobility of the input element 802 can be deliberately delayed, held and released. The input condition itself can be deposited and stored here in particular in the computer device or the input device 800 and/or the operating element 802 itself. In this way, a user receives pre-definable and programmable haptic feedback via an input. In this case, an input from the user is detected via a sensor device 5 which can detect both a pivoting movement 827 and a linear movement 826. In addition, the sensor device 5 also records the movement parameters, which here include the direction of rotation, the speed and the acceleration. A linear movement 826 of the mouse wheel 803 is generated here by pressing the mouse wheel 803 down.

In FIG. 4, a haptic mode of the method according to the invention is shown schematically here as an example for the input device 800, which is designed as a mouse wheel 803. A haptic mode describes a possible embodiment of the method for controlling the input element 802 here.

The reference symbols assigned below for the individual process features refer to arrows and pictogram-like symbols here, for example, for visualization purposes. This is intended to visualize the individual steps/characteristics of the procedure for better understanding.

The mouse wheel 804 works in the haptic mode shown here dependent on the direction 813 depending on the movement 809 in the range of movement 812. If the input element 802 embodied here as a mouse wheel 803 is rotated to the left, the braking device 1 generates a rotation-angle-dependent grid 810 with stop points 811, which the user perceives here as resistance that can be overcome when rotating. If the mouse wheel 803 is moved to the right, there is a freewheel 829 in which the mouse wheel 803 can rotate freely. This enables the user to receive direct feedback about his input.

Another haptic mode of the method is shown in FIG. 5. After a linear movement 826 of the mouse wheel 803, the mobility of the input element 802 is completely blocked by the magnetorheological braking device 1. This effectively avoids unwanted parallel incorrect input by the user. The force in the anchor point 811 is so great that a user cannot overcome it. Haptic mode is also referred to as press and block 816.

Another haptic mode is shown in FIG. 6. The grid 810 in the movement area 812 is changed here depending on the speed 814 or also depending on the acceleration 814. When the user rotates the mouse wheel 803 quickly, a distance between two adjacent grid points 811 changes as a function of the speed 814. In the movement shown, the distance between the stop points 811 decreases with increasing speed, which the user perceives when turning.

FIG. 7 shows a further embodiment of the method as a haptic mode. The input element 802 is freely rotatable here, so that there is an endless range of movement 812. In the present case, individual stop points 811 of the grid 810 are skipped 815 if there is a high acceleration of the input element 802 here.

The range of motion 812 of an input element 802 can be in depending on the haptic mode are variable and adjustable in particular. An adaptation of the mobility and a haptic feedback to the individual needs of a user or depending on a use or a program is advantageously possible in this way.

Another haptic mode of the method is shown in FIG. 8. Here the braking device is controlled with a current and/or voltage signal with a frequency 824 of 100 Hz. The sign of the frequency signal varies. As a result, a user receives haptic feedback in the form of vibration 825. A portion of the positive and negative current flow is distributed asymmetrically 823 in this case. This leads to a change and at the same time a favorable perception of the vibration 825 by the user. An audible tone 821 is also generated by the braking device 1 due to the high frequency. This haptic mode is advantageously suitable for sending an acoustic warning signal 822 to the user.

The haptic mode shown in FIG. 9 is based on activation of the braking device 1 with a random current signal 820. As a result, the wear of a bearing or, for example, sand in a transmission can be shown to a user.

A possible user interface 830 is shown in FIG. 10, through which the individual haptic modes combined into a profile 819 can be changed. The user interface 830 can have a number of setting levels 828. A user can set the control of the braking device 1 depending on the direction 813 and the speed 814 and acceleration 814. In addition, the input conditions for a skip 815 and a press and block 816 can also be set. Profiles can be saved individually 817. In addition, it is possible here to use preset profiles 818, for example from other users, in particular in a program-specific manner. In all configurations, the input device can be supplemented by an acoustic or visual output. The acoustic output can also be generated by the braking device itself.

In all of the configurations, the input device can also be expanded by sensors which are connected to the user directly or indirectly (WLAN, Bluetooth . . . ) (heart rate or heart rate monitor, blood pressure, stress level . . . ) and/or detect the environment (image recognition, ultrasound, laser, LIDAR, microphones . . . ) and from the information obtained and analyzed from this (environment information, user information) change the haptics of the input device.

List of references:

1 braking device
2 axle unit
3 rotating bodies
4 braking device
5 sensor device
6 wedge storage device
7.7a sealing device
8 wall
9 shielding device
11 connecting cable
12 bore
13 receiving space
14 connection
15 magnetic ring unit
17 sealing unit
19 shielding bodies
21 core
22 storage facility
23 finger roller
24 coil unit
25 magnetic field sensor
27 sealing part
29 separation unit
33 additional part
34 medium
35 circuit board
37 sealing part
39 decoupling device
44 brake bodies
45 signal line
46 supporting bodies
50 console
190 shielding
290 gap
291 filling medium
390 decoupling sleeve
391 decoupling gap
392 axial wall
800 input devices
801 computer mouse
802 input element
803 input wheel
804 mouse wheel
805 joystick
806 control button
807 thumb roller
808 gamepad
809 movement
810 grid
811 anchor point
812 range of motion
813 direction
814 speed, acceleration
815 skip
816 pressing and blocking
817 individually saved profiles
818 default/external profile
819 profile
820 random current signal
821 warning tone
822 warning signal
823 asymmetrical current flow
824 frequency
825 vibration
826 linear motion
827 pivoting movement
828 adjustment levels
829 freewheel
830 user interface
831 movement speed or rotational
speed
832-834 speed
833a acceleration
835 characteristic value
836 predetermined measure
837 angular position
838 buttons, switches
841, 841a-841c waveform, curve
842-844 signal
850 freewheel state
852 current time
853 start time
854 end time

1-31. (canceled)

32. A method for operating an input device, comprising:
providing at least one pivotable input element of the input device, the input element being configured to be at least partially manually operated and pivoted to carry out an input;
detecting at least one change in an angular position of the input element by at least one sensor device; and
generating a control signal which is influenced at least by the change in the angular position of the input element; and
simulating a freewheeling state of the pivotable input element from a starting time, and further generating the control signal independent of the angular position of the input element from the starting time of the freewheeling state.

33. The method according to claim 32, wherein the start time is set when the user issues a start command, the start command being able to be triggered by at least one of pressing a button or a switch, acoustic command, and optical command.

34. The method according to claim 32, wherein the start time is set automatically when a characteristic value for a temporal change in the angular position of the input element exceeds a predetermined level.

35. The method according to claim 32, wherein the simulation of the freewheeling state is ended when the user makes another input.

36. The method according to claim 32, wherein the simulation of the freewheeling state is ended when the input element is not rotating and the user begins to rotate the input element, and the sensor device detects a change in the angular position.

37. The method according to claim 32, wherein the simulation of the freewheeling state is ended when the input element rotates and the user actively changes and brakes or accelerates the speed of the input element.

38. The method according to claim 32, wherein in the freewheeling state, the control signal is generated independent of the temporal change in the angular position of the input element.

39. The method according to claim 32, wherein the control signal is generated based on at least one parameter from a group of parameters consisting of a current angular position, a current rotational speed, a current angular acceleration, and a current point in time.

40. The method according to claim 34, wherein when the predetermined measure is exceeded, the control signal is further generated based in part on the speed of the input element and/or the acceleration of the input element.

41. The method according to claim 34, wherein the characteristic value is derived from a speed and/or an acceleration of the input element.

42. The method according to claim 34, wherein the control signal after the starting time is greater than the control signal at the time at which the characteristic value for a temporal change in the angular position of the input element exceeds a predetermined level.

43. The method according to claim 32, wherein the control signal is generated depending on a time period from the start time.

44. The method according to claim 43, wherein a decrease in the speed of the input element over time is simulated during the freewheeling state.

45. The method according to claim 32, wherein a temporal length of the freewheeling state is limited.

46. The method according to claim 32, wherein the behavior of the user is evaluated by artificial intelligence and the control signal in the freewheeling state is adjusted depending on the evaluation.

47. The method according to claim 32, wherein a level of the control signal depends on at least one of the length of a document, the number of list entries in a list, the number of Menti entries of a Mentis, and a travel path.

48. The method according to claim 32, wherein the input element can be rotated at least several revolutions.

49. The method according to claim 32, wherein at least one rotation of the input element is specifically delayed, held and released by means of at least one controllable magnetorheological braking device.

50. The method according to claim 32, wherein the mobility of the input element is specifically adjusted at least as a function of at least one input condition, and wherein the input condition comprises at least one movement parameter.

51. The method according to claim 50, wherein the movement parameter has at least one direction, a speed, and/or an acceleration of a movement of the input element.

52. The method according to claim 32, wherein:
the mobility of the input element is specified and/or influenced at least as a function of a profile, which has at least two input conditions that are at least partially dependent on one another and which are at least partially determined by a user; and
the profile is individually customizable by a user interface of a computer device, and/or the profile is particularly individually customizable based on environmental information/user information.

53. The method according to claim 32, wherein within a movement range of the input element, a grid with stop points is generated by a braking device depending on at least one movement parameter, which determines the mobility and a movement of the input element is influenced.

54. The method according to claim 32, wherein:
the input element is used for scrolling;
the mobility of the input element changes depending on the scrolling;
the mobility of the input element is set depending on an activity of a program running in the background and/or depending on an operating state of an operating system of a computer device; and/or
the mobility of the input element is set depending on a zooming process and wherein zooming in along a direction of movement occurs with a delay and zooming out in an opposite direction of movement occurs with a different delay than for zooming out.

55. The method according to claim 32, wherein when an input is made in at least one input menu with inactive and active input fields, and the mobility of the input element is set depending on whether the input field is inactive or active.

56. The method according to claim 32, wherein:
the mobility of the input element is changed in order to provide a haptic confirmation of a previously made input;
in the event of an incorrect and/or implausible and/or critical input, the mobility of the input element is delayed or blocked; and/or
after an input the mobility of the input element is delayed or held until at least one further user input has been made.

57. The method according to claim 32, wherein the input device is used for gaming on a gaming device, the mobility of the input element is set depending on a scenario generated by the gaming device and the mobility of the input element is configured to have a greater delay where a greater force is fictitiously required in the scenario and/or the more difficult the action that is fictitiously carried out in the scenario.

58. The method according to claim 32, wherein the mobility of the input element can be adjusted by user input.

59. The method according to claim 32, wherein the input element has at least one input wheel, the input takes place at least by rotating the input wheel, and the rotatability of the input wheel can be specifically delayed, held, and released by a braking device.

60. The method according to claim 50, wherein the input condition is also dynamically adjusted depending on the input, so that the mobility of the input element is also adjusted by the input made according to the principle of feedback.

61. The method according to claim 32, wherein the rotational movement of the operating part is braked by a braking device depending on an operating state of a motor vehicle, and the operating state includes at least one driving mode and at least one stationary mode.

62. An input device for carrying out the method according to claim 32.
